(19) United States
(12) Patent Application Publication
(10) Pub. No.: US 2023/0251384 A1
(43) Pub. Date: Aug. 10, 2023

(54) AUGMENTATION OF SENSOR DATA UNDER VARIOUS WEATHER CONDITIONS TO TRAIN MACHINE-LEARNING SYSTEMS

(71) Applicant: GM Cruise Holdings LLC, San Francisco, CA (US)

(72) Inventor: Sandeep Gangundi, San Jose, CA (US)

(21) Appl. No.: 17/668,229

(22) Filed: Feb. 9, 2022

(51) Int. Cl. G01S 17/931; G01S 17/89; G01S 7/48; G06N 20/00

(52) U.S. Cl. CPC G01S 17/931; G01S 17/89; G01S 7/4802; G06N 20/00

(57) ABSTRACT

The present technology is directed to generating augmented data that are used for training a machine-learning (ML) algorithm to recognize objects under different weather conditions. The present technology may include receiving, by one or more processors, data of an environment including objects in a first geographical location. The data of the environment may be received from sensors on a vehicle moving on a road under a first weather condition. The present technology may also include receiving reference data that represent a second weather condition. The second weather condition may include a precipitation type. The present technology may also include generating augmented data including a subset of the reference data superimposed on the data of the environment. The augmented data simulates the environment under the second weather condition to simulate the environment under the second weather condition. The present technology may include providing the augmented data to an ML algorithm for training the ML algorithm to recognize the objects in the environment under the second weather condition.

### TECHNICAL FIELD

The subject technology pertains to generating augmented data that include weather effects on sensor data and training machine-learning models using the augmented data.

### BACKGROUND

An autonomous vehicle (AV) is a motorized vehicle that can navigate without a human driver. An exemplary autonomous vehicle includes a plurality of sensor systems, including a camera sensor system, a Light Detection and Ranging (LiDAR) sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. In some applications, these systems utilize a perception system (or perception stack) that implements various computing vision techniques to understand the surrounding environment.

### SUMMARY

In one aspect, the present technology is directed to generating augmented data that are used for training a machine-learning (ML) algorithm to recognize objects under different weather conditions. The present technology may include receiving, by one or more processors, data of an environment including objects in a first geographical location. The data of the environment may be received from sensors on a vehicle moving on a road under a first weather condition. The present technology may also include receiving reference data that represent a second weather condition. The second weather condition may include a precipitation type. The present technology may also include generating augmented data including a subset of the reference data superimposed on the data of the environment. The augmented data simulates the environment under the second weather condition to simulate the environment under the second weather condition. The present technology may include providing the augmented data to an ML algorithm for training the ML algorithm to recognize the objects in the environment under the second weather condition.

In another aspect, the present technology is directed to training the ML algorithm to recognize objects under different weather conditions. The present technology may include training the ML algorithm at a first random noise level in the augmented data that simulates a third weather condition to recognize one or more of the objects. The present technology may also include increasing a noise level from the first random noise level to a second noise level in the augmented data that simulates a fourth weather condition. The present technology may also include training the ML algorithm at the second random noise level that simulates the fourth weather condition to recognize one or more of the objects. The present technology may also include detecting, via the ML algorithm, one or more borders of the objects on the road. The present technology may also include predicting, via the ML algorithm, the presence of one or more of the objects in the environment under the second weather condition. The present technology may include generating object labels for the one or more of the objects.

Additional aspects, embodiments, and features are set forth in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more autonomous vehicles (AVs) in accordance with some aspects of the present technology;

FIG. 2 illustrates an example method for generating augmented data that are used for training an ML algorithm to recognize objects under different weather conditions in accordance with some aspects of the present technology;

FIG. 3 illustrates an example method for training an ML algorithm to recognize objects under different weather conditions in accordance with some aspects of the present technology;

FIG. 4A illustrates example data collected from a LIDAR sensor in light rain in accordance with some aspects of the present technology;

FIG. 4B illustrates example data collected from a LIDAR sensor in medium rain in accordance with some aspects of the present technology;

FIG. 4C illustrates example data collected from a LIDAR sensor in heavy rain in accordance with some aspects of the present technology;

FIG. 5 illustrates an example bird-eye view (BEV) of LIDAR data with prediction boxes for objects detected based upon a machine-learning model of BEV in accordance with some aspects of the present technology;

FIG. 6 illustrates an example perspective view of LIDAR data with prediction boxes for objects detected based upon a machine-learning model of a perspective view in accordance with some aspects of the present technology;

FIG. 7 illustrates an example front view of camera data with prediction boxes for objects detected based upon a machine-learning model of a single-shot detector (SSD) in accordance with some aspects of the present technology; and

FIG. 8 is an example of a computing system in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form to facilitate describing one or more aspects. Further, it is to be understood that functionality described as being carried out by certain system components may be performed by more or fewer components than shown.

As described herein, one aspect of the present technology is gathering and using data from various sources to improve the ride quality and ride experience for a passenger in an autonomous vehicle. The present disclosure contemplates that in some instances, this gathered data may include personal information. The present disclosure contemplates that the entities involved with such personal information respect and value privacy policies and practices.

Common sensors used in autonomous vehicles, such as camera sensor systems, Light Detection and Ranging (LiDAR) sensors, radar sensors, or acoustic sensors, are susceptible to the environment, such as rainy, snowy, or foggy weather. It is difficult to understand how machine-learning (ML) models for autonomous vehicles (AVs) perform in certain weather conditions such as, for example, rainy, snowy, or foggy weather. The AVs may have to wait for a desired geographical location to have certain weather conditions, such as rain, to collect weather-related data to train the ML models and/or determine their performance under such weather conditions. After waiting for the weather conditions in the desired geographical location, the AVs can be launched or deployed to collect data from various sensors, such as LIDAR sensors and camera sensors. The data collected from the sensors can be used to train the ML models and systems to operate under certain weather conditions. This approach of training the ML models strongly depends upon the weather conditions under which the AVs can be launched.

This approach of training the ML systems is onerous and very expensive because the AVs need to be moved to different places to collect data under different weather conditions. For example, when the AVs are launched in cities where there may be heavy snow, the AVs may be deployed there to collect data from the sensors. The data can be used to train the ML models that navigate the AVs and/or interpret the data generated by sensors of the AVs.

In some cases, an AV can implement certain sensors that can work better under different weather (and/or environment) conditions (e.g., rain, snow, fog, drizzle, smoke, heavy winds, etc.) than other weather (and/or environment) conditions such as clear skies. However, while the sensors may work better under various weather conditions, the AVs still need to be deployed to collect data for different weather conditions to train the system for those weather conditions. Accordingly, such approaches remain onerous and costly.

Aspects of the disclosed technology provide solutions for the augmentation of reference sensor data collected from sensors to capture various weather conditions and understand the impact of the various weather conditions on the ML models and systems. The present technology allows the expansion of the sensor data to include various weather conditions.

The reference sensor data can be collected under various weather conditions, such as rain, snow, or fog. From the reference data, the effects of the various weather conditions on different sensors can be understood. One may go to actual locations that may often have certain weather conditions to collect some reference data from sensors and may understand how these weather conditions affect the reference data. This collection may be done one time with one vehicle. Then, the effect of the weather conditions on the data from the sensors can be analyzed to determine how different levels of rain, snow, or fog may affect sensor data. For the weather data like rain or snow, one may collect the reference data in a different location or different time, then the weather data can be added to street data in any other locations or the same location but at different times.

In some examples, a subset of the reference data can be augmented to the other sensor data (e.g. data collected under other weather conditions, such as weather conditions without rain, snow, or fog and/or with clear visibility) to simulate various weather conditions. In some cases, the augmentation of data can include superimposing the reference data from the sensors under various weather conditions to the other sensor data obtained under different weather conditions, such as weather conditions without rain, snow, or fog and/or with clear visibility.

The augmented data can be used to train the ML models implemented by the AVs. The training can help improve the utility and accuracy of these ML models in navigating the AVs. The augmentation approach avoids collecting the data in real-time from the sensors in different locations and thus can reduce costs associated with training ML models by launching AVs in various weather conditions based upon data collected from the sensors in real-time. The present technology can also be easily expanded to other geographic locations.

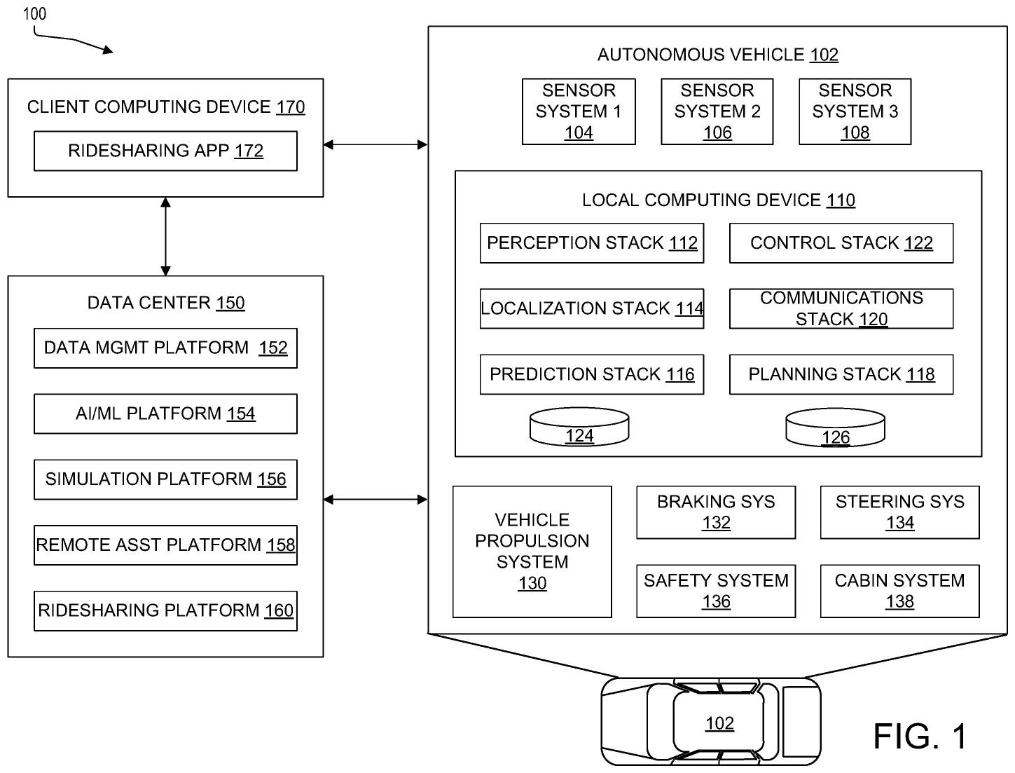

FIG. 1 illustrates an example of an AV management system 100. One of the ordinary skills in the art will understand that there can be additional or fewer components in similar or alternative configurations for the AV management system 100 and any system discussed in the present disclosure. The illustrations and examples provided in the present disclosure are for conciseness and clarity. Other embodiments may include different numbers and/or types of elements, but one of the ordinary skills in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, sensor system 104 can be a camera system, sensor system 106 can be a LIDAR system, and sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along with the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., the direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left-turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112—122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine-learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine-learning (AI/ML) platform 154, a simulation platform 156, remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having differently structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time-series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine-learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine-learning models; evaluate, refine, and deploy the models; maintain, monitor, and retrain the models; and so on.

The simulation platform 156 can enable testing and validation of the algorithms, machine-learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other systems of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing devices for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

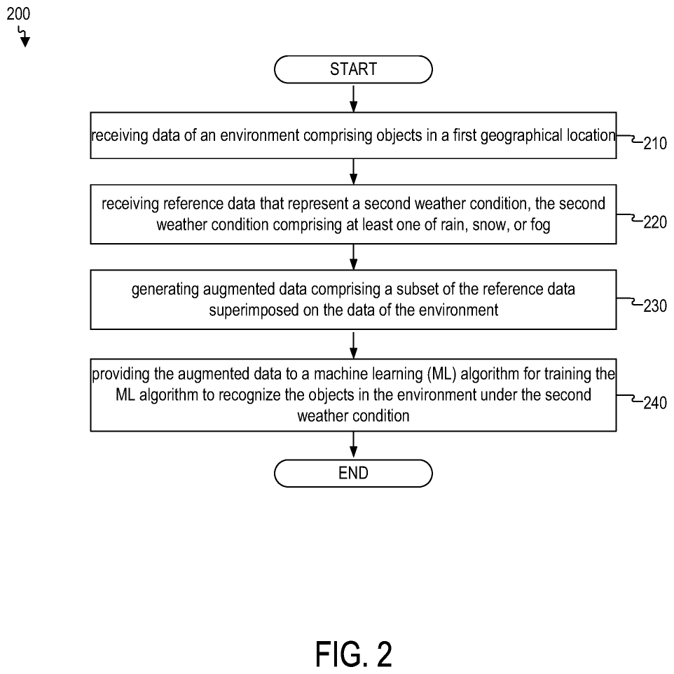

FIG. 2 illustrates an example method 200 for generating augmented data used for training an ML algorithm to recognize objects under different weather conditions, in accordance with some aspects of the present technology. Although the example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements the method 200 may perform functions at substantially the same time or in a specific sequence.

According to some examples, at block 210, the method 200 may include receiving data of an environment comprising objects in a first geographical location. In some examples, the data of the environment can be received from sensors on a vehicle moving on a road under a first weather condition. For example, the local computing system 110 as illustrated in FIG. 1 may receive data of an environment comprising objects in a first geographical location, the data of the environment be received from sensors on a vehicle moving on a road under a first weather condition. The first weather condition can include, for example and without limitation, weather without rain, snow, or fog and/or weather with a threshold visibility. In some examples, the first weather condition may be sunny or a clear sky.

In some aspects, the vehicle may include an autonomous vehicle.

In some aspects, the objects in the environment may include at least one of a car, a truck, a transporting vehicle, a pedestrian, a bike, an obstacle, and/or any other objects or combinations thereof.

In some aspects, the sensors may include LIDAR sensors, camera sensors, RADAR sensors, acoustic sensors, among others.

According to some examples, at block 220, the method 200 may include receiving reference data that represent a second weather condition. In some examples, the second weather condition can include at least one of rain, snow, or fog. For example, the local computing system 110 illustrated in FIG. 1 may receive reference data that represent a second weather condition that includes a precipitation type, which may include any amount of moisture in the air (e.g., fog) and/or falling from the sky (e.g., rain, sleet, or snow), and/or any other weather condition or combinations thereof. In some aspects, precipitation can have a negative impact on the performance of sensors (and/or the data collected by the sensors). For example, rain includes water droplets, which can reflect the light beam from LIDAR sensors. Snow includes ice crystals, which can also reflect the light beam from LIDAR sensors. Fog may include very small water droplets, which can also reflect the light beam from LIDAR sensors. In some cases, snow and rain may generate more noise than fog for the LIDAR sensors.

In some aspects, the reference data (e.g., weather data) can be collected in a second geographical location different from the first geographical location or a second time in the first geographical location. For example, the second geographical location may be in a different city, a different state, or a different country. As an example, snow data may be collected by using LIDAR sensors or camera sensors in a heavy snow region, and the snow data can be used to augment data for a different region, such as San Francisco.

Also, the reference data may be collected at a different time in the first geological location. For example, snow data may be collected in winter in the first geographical location, while the data of the environment may be collected in summer in the same first geographical location.

According to some examples, at block 230, the method 200 may include generating augmented data comprising a subset of the reference data superimposed on the data of the environment. For example, the local computing system 110 illustrated in FIG. 1 may generate augmented data by superimposing a subset of the reference data on the data of the environment. The augmented data can simulate the environment under the second weather condition.

For example, a system may obtain an image from a camera sensor and process the image by adding noise patterns generated by certain weather conditions (e.g., rain, snow, fog, drizzle, dust storm, wind, etc.) to create augmented data. The augmented data can include the image with an amount of haziness in streaks that imitate rain. Likewise, the approach may be expanded to any weather conditions to determine and/or simulate the effects of the weather conditions on the image data.

Also, the approach may be expanded to other sensors, such as LIDAR sensors. Once the effect of the weather conditions on LiDAR data from the LIDAR sensors can be understood or determined, the approach may include superimposing the effect of the weather conditions to other LIDAR data obtained under different weather conditions (e.g., sunny, no precipitation, clear sky, visibility above a threshold, etc.).

In some aspects, the reference data under any weather condition may be superimposed on the top of one or more images and/or data corresponding to other weather/environment conditions, other geographic areas, etc.

In some aspects, the subset of the reference data is representative of the second weather condition. In some cases, the subset of the reference data is not representative of a second environment in the second geographical location. Sensor data collected in a region under certain weather (e.g., snow, rain, fog, etc.) can be extracted from the data collected from the LIDAR sensors or camera sensors to remove the objects in the second environment, such as the environment in New York City. The sensor data collected can be used to augment the data of any other environment (e.g., any other city, state, country, terrain, etc.).

In some aspects, the sensors may include one or more LIDAR sensors that generate LIDAR data including the objects made up of a plurality of point clouds. The subset of reference data may include randomly scattered point clouds that represent light reflections from precipitation such as, for example, rain, snow, fog, or any other precipitation or combination thereof. The augmented data may include the plurality of point clouds from the LIDAR sensors superimposed with the randomly scattered point clouds.

In some aspects, the sensors may include camera sensors that generate image data depicting the objects. The reference data may include randomly scattered pixels that represent light reflections from precipitation such as, for example, rain, snow, fog, or any other precipitation or combination thereof. The augmented data may include the image data from the camera sensors superimposed with the randomly scattered pixels.

In some aspects, the image data may include two-dimensional (2D) image frames depicting the objects made up of a plurality of pixels.

In some aspects, the sensors may include stereo cameras. The image data may include 3D images depicting the objects.

According to some examples, at block 240, the method 200 may include providing the augmented data to a machine learning (ML) algorithm for training the ML algorithm to recognize the objects in the environment under the second weather condition. For example, the local computing system 110 illustrated in FIG. 1 may use the augmented data to train a machine learning (ML) algorithm to recognize the objects in the environment under the second weather condition.

This augmentation approach also saves time because large amounts of data can be generated in a short duration using software. There is no need to wait for the AVs to collect data under certain weather conditions.

The present technology provides a very efficient, accurate, and cost-efficient approach for training the ML models. One may control the noise that simulates any type or amount of precipitation such as, for example, light rain, medium rain, or heavy rain. Also, the present technology provides a flexible approach that can add the weather data to different sceneries or different places, like San Francisco, New York, or any other place. For example, even if there is no snow in San Francisco, one may add snow data on the San Francisco data for training the ML models.

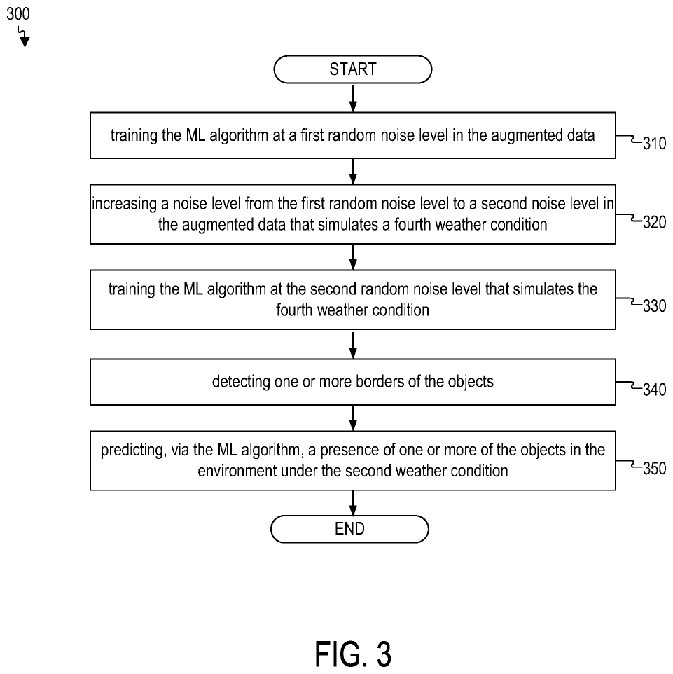

FIG. 3 illustrates an example method for training an ML algorithm to recognize objects under different weather conditions, in accordance with some aspects of the present technology. Although an example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, at block 310, the method 300 may include training the ML algorithm with a first random noise level in the augmented data. For example, the AI/ML platform 154 illustrated in FIG. 1 may train the ML algorithm at a first random noise level in the augmented data, which simulates a third weather condition, e.g., light rain, storm, light snow, light fog, dust storm, etc. The third weather condition is simulated and may be different from the first weather condition. The third weather condition may also be different from the second weather condition when the weather data were originally collected. The ML algorithm can recognize one or more of the objects.

In some aspects, the subset of the reference data may be divided into a plurality of categories that correspond to a plurality of random noise levels in the augmented data.

According to some examples, at block 320, the method 300 may include increasing a noise level from the first random noise level to a second noise level in the augmented data that simulates a fourth weather condition. For example, the AI/ML platform 154 illustrated in FIG. 1 may increase a noise level from the first random noise level to a second noise level in the augmented data that simulates a fourth weather condition, such as heavy rain, storm, heavy snow, or heavy fog. The fourth weather condition is also simulated and may be different from the first, second, and third weather conditions.

According to some examples, at block 330, the method 300 may include training the ML algorithm at the second random noise level that simulates the fourth weather condition. For example, the AI/ML platform 154 illustrated in FIG. 1 may train the ML algorithm at the second random noise level that simulates the second weather condition. The ML algorithm can recognize one or more of the objects in the simulated fourth weather condition (e.g., heavy rain or heavy snow).

According to some examples, at block 340, the method 300 may include detecting one or more borders of the objects on the road. For example, the AI/ML platform 154 illustrated in FIG. 1 may detect one or more borders of the objects on the road. The ML algorithm may include an edge detection function, which can detect one or more borders of the objects on the road.

In some aspects, the ML algorithm may evaluate the augmented LIDAR data in a bird-eye view (BEV). BEV is a representation for road scenes that captures surrounding objects and their spatial locations, along with the overall context in the scene. The ML model can transform on-road images to semantically segmented BEV images.

In some aspects, the ML algorithm may evaluate the augmented LIDAR data in a perspective view.

In some aspects, the ML algorithm may be a single-shot detector (SSD) ML model for evaluating camera data. SSD is designed for object detection in real-time. The SSD object detection can include extracting feature maps, and applying convolution filters to detect objects. Each prediction composes boundary box.

According to some examples, at block 350, the method 300 may include predicting, via the ML algorithm, the presence of one or more of the objects in the environment under the second weather condition. For example, the AI/ML platform 154 illustrated in FIG. 1 may predict, via the ML algorithm, the presence of one or more of the objects in the environment under the second weather condition. In some examples, the second weather condition may include precipitation such as, for example, rain, snow, fog, etc.

According to some examples, at block 360, the method 300 may include generating object labels for one or more of the objects. For example, the AI/ML platform 154 illustrated in FIG. 1 may generate object labels for one or more of the objects. The object labels can be generated for the objects, such as cars, trucks, transporting vehicles, pedestrians, or bikes, among others. The labels may be provided to the ML model that navigates the AVs.

The augmentation approach may be applied to any sensors, so the effects of various weather conditions, such as rain, snow, or fog, on the sensor data can be understood for these sensors. By using the approaches described herein, the system may create augmented data in various weather conditions. For example, if there are 1 million data sets in certain weather conditions, the system may generate 1 million data sets in any other weather condition, such as rain, snow, or fog, among others.

The ML models can learn based on large data sets. The system may augment all the weather-related artifacts on the large data sets to train ML models. For example, when there are large amounts of hazy images, the ML models may learn from these hazy images. Even in all hazy images, the ML models can recognize if there is a pattern that may indicate the presence of an object (e.g., a vehicle, pedestrian, etc.) there.

The following examples are for illustration purposes only. It will be apparent to those skilled in the art that many modifications, both to materials and methods, may be practiced without departing from the scope of the disclosure.

A system may collect reference data from sensors in various weather conditions and learn characteristics of the weather conditions on sensor data such as image data or LIDAR data. In some cases, there are different levels for each weather condition, such as rain or snow.

As an example, rain may create randomly scattered point clouds in LIDAR data. Experiments may be performed with different levels of rain, which may be categorized as light rain, medium rain, and heavy rain. When the rain is light, it may be visible to view things by the camera sensors. When the rain is medium, objects may still be visible in images captured by the camera sensors. However, when the rain becomes too heavy, it may be too hazy to view things in images captured by the camera sensors.

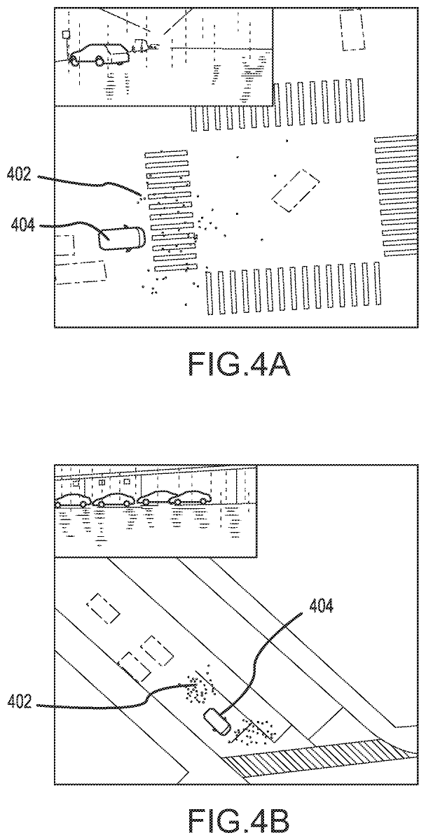

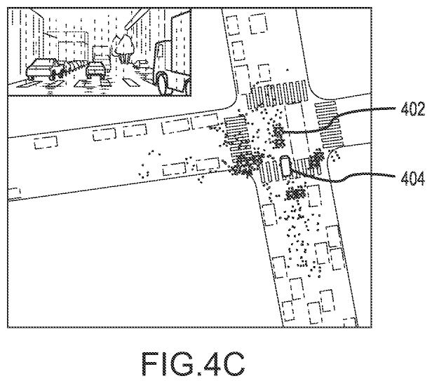

FIG. 4A illustrates example data collected from a LIDAR sensor in light rain, in accordance with some aspects of the present technology. As illustrated in FIG. 4A, small and randomly scattered point clouds 402 represent light reflections from rain droplets near vehicle 404. The LIDAR beam is reflected off the rain droplets and returned to the LIDAR sensor.

FIG. 4B illustrates example data collected from a LIDAR sensor in medium rain, in accordance with some aspects of the present technology. As illustrated in medium rain, point clouds 402 are more closely located near vehicle 404 as compared to that in the light rain as illustrated in FIG. 4A.

FIG. 4C illustrates example data collected from a LIDAR sensor in heavy rain, in accordance with some aspects of the present technology. As illustrated, in the heavy rain, the point clouds 402 become more closely packed near vehicle 404 than those in FIGS. 4A and 4B.

Experiments may be performed by LIDAR sensors for various weather conditions such as rain, snow, fog, etc. Similarly, light reflections can be collected from snowflakes.

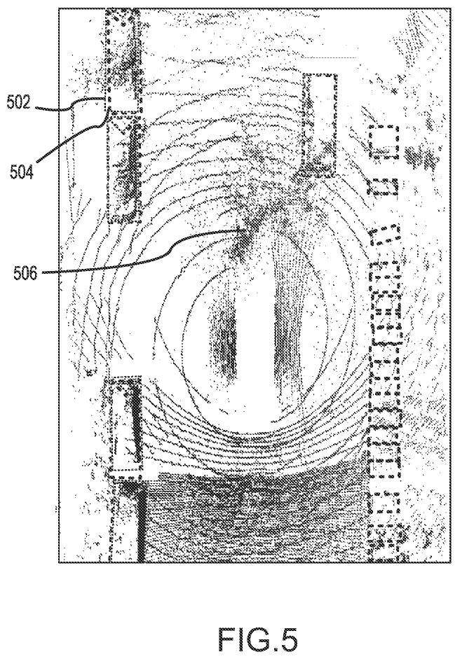

Different ML models may be used for predictions. The ML model may be a bird-eye view (BEV) ML model, which views the LIDAR data from top-down. FIG. 5 illustrates an example BEV of LIDAR data with prediction boxes for objects detected based upon a machine-learning model of BEV, in accordance with some aspects of the present technology. As illustrated in FIG. 5, there are a lot of scattered point clouds 506, which create large amounts of noise. Even with the noise, the ML model of BEV can be trained to recognize objects in the rain and can still determine that there are cars in the prediction boxes 504. Boxes 502 are the prediction from the ML model of BEV, while boxes 504 are the ground truth. As illustrated, the labels 502 and 504 are substantially superimposed on the same image. Both boxes 502 and 504 indicate the presence of cars at the locations of the boxes.

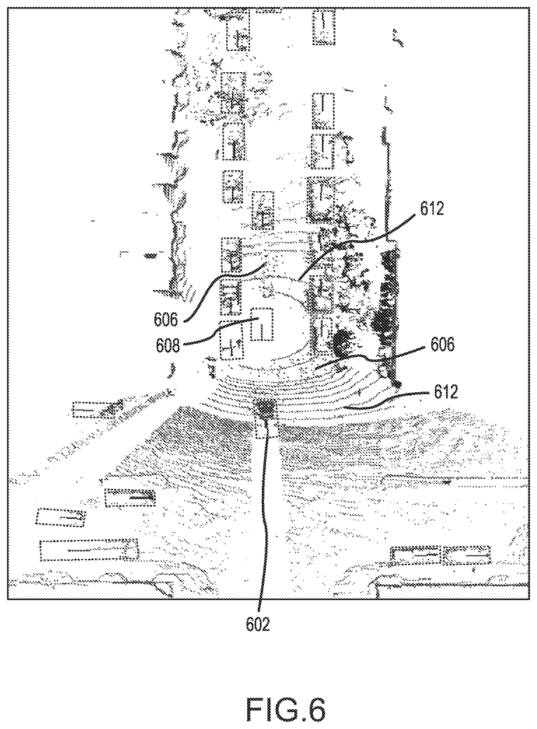

The ML model may also be a perspective view model, which can yield a similar prediction to the BEV ML model. FIG. 6 illustrates an example perspective view of LIDAR data with prediction boxes for objects detected based upon a machine-learning model of a perspective view, in accordance with some aspects of the present technology. As illustrated in FIG. 6, there are a lot of scattered point clouds 606, which create large amounts of noise. Even with the noise, the ML model of BEV can be trained to recognize objects in the rain and can still determine that there are cars in the prediction boxes 604. Boxes 602 are the prediction from the ML model in a perspective view, which are similar to the ground truth box (not shown). As illustrated, the labels 602 and 604 are substantially superimposed on the same image. Both boxes 602 and 604 indicate the presence of cars at the locations of the boxes.

In the perspective view as illustrated in FIG. 6, a car 614 is straight ahead of an AV 608 on road 610. A LIDAR sensor spins in 360 degrees, which creates concentric circles 612.

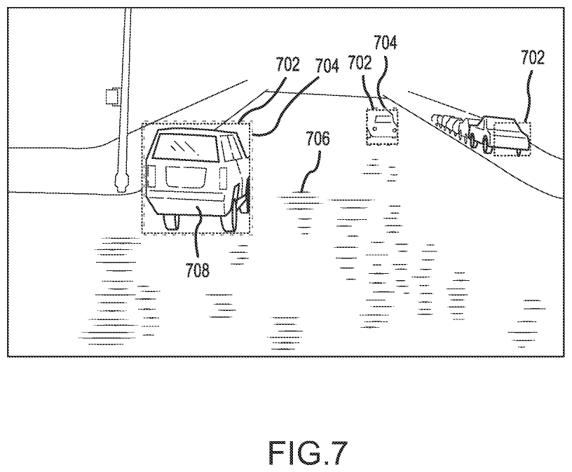

As illustrated above, there is a lot of random noise generated from precipitation on the LIDAR data. For camera images, the precipitation may create streaks of light as illustrated in FIG. 7. FIG. 7 illustrates an example front view of camera data with prediction boxes for objects detected based upon a machine-learning model of a single-shot detector (SSD), in accordance with some aspects of the present technology. As illustrated in FIG. 7, even with noise in the camera data from the rain, the ML model of SSD can be trained to recognize objects in the boxes in the rain. Boxes 702 are the prediction from the ML model of SSD in a perspective view, while boxes 704 are the ground truth. The streak of lights 706 is an indication of rain. As illustrated, the labels 702 and 704 are substantially superimposed on the same image. Both boxes 702 and 704 indicate the presence of cars at the locations of the boxes.

With the understanding of the effect of precipitation on LIDAR data and camera data, randomly scattered noise types may be created to simulate the effect of rain on LIDAR data or camera data to generate augmented data. The augmented data can be used for training ML models or systems. Noise from the weather can be added to the normal sensor data to train the ML models. As such, the ML model is trained from the augmented data including weather conditions. This saves time otherwise required to collect data sets in rain or snow, among other weather conditions.

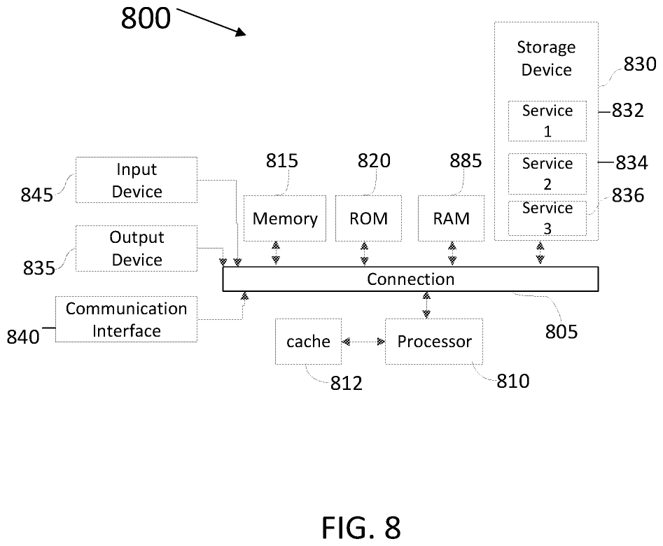

FIG. 8 shows an example of computing system 800, which can be, for example, used for all the calculations as discussed above, or can be any computing device making up the local computing system 110, remote computing system 150, (potential) passenger device executing rideshare app 170, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

The example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, close to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of many output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer-readable media which can store data that are accessible by a computer, such as magnetic cassettes, flash memory cards, solid-state memory devices, digital versatile disks, cartridges, random access memories (RAMs), read-only memory (ROM), and/or some combination of these devices.

The storage device 830 can include software services, servers, services, etc., and when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving, by one or more processors, data of an environment comprising objects in a first geographical location, the data of the environment being received from sensors on a vehicle moving on a road under a first weather condition;
receiving reference data that represent a second weather condition, the second weather condition comprising a precipitation type;
generating augmented data comprising a subset of the reference data superimposed on the data of the environment, wherein the augmented data simulates the environment under the second weather condition; and
providing the augmented data to a machine learning (ML) algorithm for training the ML algorithm to recognize the objects in the environment under the second weather condition.

2. The method of claim 1, wherein the reference data are collected in a second geographical location different from the first geographical location or a second time in the first geographical location.

3. The method of claim 1, wherein the subset of the reference data is representative of the second weather condition and is not representative of a second environment in the second geographical location.

4. The method of claim 1, wherein the sensors comprise one or more light detection and ranging (LIDAR) sensors that generate LIDAR data comprising the objects made up of a plurality of point clouds, wherein the subset of reference data comprises randomly scattered point clouds that represent light reflections from the precipitation type, wherein the augmented data comprise the plurality of point clouds from the LIDAR sensors superimposed with the randomly scattered point clouds.

5. The method of claim 1, wherein the sensors comprise camera sensors that generate image data depicting the objects, wherein the reference data comprise randomly scattered pixels that represent light reflections from the precipitation type, wherein the augmented data comprise the image data from the camera sensors superimposed with the randomly scattered pixels.

6. The method of claim 1, wherein the subset of the reference data is divided into a plurality of categories that correspond to a plurality of random noise levels in the augmented data.

7. The method of claim 1, further comprising:
training the ML algorithm at a first random noise level in the augmented data that simulates a third weather condition to recognize one or more of the objects;
increasing a noise level from the first random noise level to a second noise level in the augmented data that simulates a fourth weather condition; and
training the ML algorithm at the second random noise level that simulates the fourth weather condition to recognize one or more of the objects.

8. The method of claim 1, further comprising:
detecting, via the ML algorithm, one or more borders of the objects on the road;
predicting, via the ML algorithm, a presence of one or more of the objects in the environment under the second weather condition; and
generating object labels for the one or more of the objects.

9. A system comprising:
a storage device configured to store instructions;
one or more processors configured to execute the instructions, wherein the instructions, when executed by the one or more processors, cause the one or more processors to:
receive data of an environment comprising objects in a first geographical location, the data of the environment be received from sensors on a vehicle moving on a road under a first weather condition,
receive reference data that represent a second weather condition, the second weather condition comprising a precipitation type;
generate augmented data comprising a subset of the reference data superimposed on the data of the environment, wherein the augmented data simulates the environment under the second weather condition, and
provide the augmented data to a machine learning (ML) algorithm for training the ML algorithm to recognize the objects in the environment under the second weather condition.

10. The system of claim 9, wherein the sensors comprise one or more light detection and ranging (LIDAR) sensors that generate LIDAR data comprising the objects made up of a plurality of point clouds, the subset of reference data comprises randomly scattered point clouds that represent light reflections from the precipitation type, and the augmented data comprise the plurality of point clouds from the LIDAR sensors superimposed with the randomly scattered point clouds.

11. The system of claim 9, wherein the sensors comprise camera sensors that generate image data depicting the objects, the reference data comprise randomly scattered pixels that represent light reflections from the precipitation type, and the augmented data comprise the image data from the camera sensors superimposed with the randomly scattered pixels.

12. The system of claim 9, wherein the instructions, when executed by the one or more processors, cause the one or more processors to:
train the ML algorithm at a first random noise level in the augmented data that simulates a third weather condition to recognize one or more of the objects;
increase a noise level from the first random noise level to a second noise level in the augmented data that simulates a fourth weather condition; and
train the ML algorithm at the second random noise level that simulates the fourth weather condition to recognize one or more of the objects.

13. The system of claim 9, wherein the instructions, when executed by the one or more processors, cause the one or more processors to:
detect, via the ML algorithm, one or more borders of the objects on the road;
predict, via the ML algorithm, a presence of one or more of the objects in the environment under the second weather condition; and
generate object labels for the one or more of the objects.

14. The system of claim 9, wherein the vehicle comprises an autonomous vehicle.

15. The system of claim 9, wherein the objects in the environment comprise at least one of a car, a truck, a transporting vehicle, a pedestrian, or a bike.

16. A non-transitory computer readable-medium comprising instructions, the instructions, when executed by a computing system, cause the computing system to:
receive data of an environment comprising objects in a first geographical location, the data of the environment be received from sensors on a vehicle moving on a road under a first weather condition;
receive reference data that represent a second weather condition, the second weather condition comprising a precipitation type;
generate augmented data comprising a subset of the reference data superimposed on the data of the environment, wherein the augmented data simulates the environment under the second weather condition; and
provide the augmented data to a machine learning (ML) algorithm for training the ML algorithm to recognize the objects in the environment under the second weather condition.

17. The computer readable-medium of claim 16, wherein the reference data are collected in a second geographical location different from the first geographical location or a second time in the first geographical location.

18. The computer readable-medium of claim 16, wherein the subset of the reference data is representative of the second weather condition and is not representative of a second environment in the second geographical location.

19. The computer readable-medium of claim 16, wherein the computer readable-medium further comprises instructions that, when executed by the computing system, cause the computing system to:
train the ML algorithm at a first random noise level in the augmented data that simulates a third weather condition to recognize one or more of the objects;
increase a noise level from the first random noise level to a second noise level in the augmented data that simulates a fourth weather condition; and
train the ML algorithm at the second random noise level that simulates the fourth weather condition to recognize one or more of the objects.

20. The computer readable-medium of claim 16, wherein the computer readable-medium further comprises instructions that, when executed by the computing system, cause the computing system to:
detect, via the ML algorithm, one or more borders of the objects on the road;
predict, via the ML algorithm, a presence of one or more of the objects in the environment under the second weather condition; and
generate object labels for the one or more of the objects.
